(19) United States
(12) Patent Application Publication
(10) Pub. No.: US 2005/0039696 A1
(43) Pub. Date: Feb. 24, 2005

(54) Always upright shape for dog bones

(76) Inventor: Adam J. Springer, Astoria, NY (US)

Correspondence Address: ROBERT S. STOLL;STOLL, MISKIN, HOFFMAN & BADIE, 4710 Empire State Building, New York, NY, 10118, US

(21) Appl. No.: 10/920,668

(22) Filed: Aug. 18, 2004

Related U.S. Application Data
(60) Provisional application No. 60/496,737, filed on Aug. 21, 2003.

(51) Int. Cl. A01K 29/00

(52) U.S. Cl. 119/709

(57) ABSTRACT

A chewable animal toy (dog bone) having multiple extensions radiating from a core with some of the extensions serving as supports for the toy on a horizontal surface and with at least one other extension extending above the core. When all the extensions are of equal length, equidistant from each other and at equal angles with respect to each other, any combination of at least three extensions serve as support for the toy with another extension extending upwardly for ease of animal play or chewing. When there are at least four extensions with at least three of the extensions being of substiantially equal length and being at substantially equal angles with respect to each other, those three extensions serve as support for the toy on a horizontal surface and at least a fourth extension extends above the core.

### CROSS REFERENCE TO RELATED APPLICATION

This application claims the benefit of Provisional Patent Application Ser. No. 60/496,737, filed Aug. 21, 2003.

### FIELD OF INVENTION

This invention relates to the field of pet toys, specifically to “dog bones” which meant to be chewed on, and gradually consumed by the animal.

### BACKGROUND OF THE INVENTION

A dog bone is an animal chew toy, which can be created from a wide range of materials palatable to the animal, that is meant to be chewed on and slowly consumed by the animal. Conventional dog bones lay flat on the floor. Before a dog can chew on the bone, he must manipulate it into an upright or elevated position in order to have full access to the toy for chewing. This is difficult for a typical dog to accomplish with its paws. The animal often spends as much time dropping, picking up, and positioning the toy as it spends chewing on it. This detracts from a dog's entertainment and pleasure, in that the animal would much rather devote all of its energy to chewing.

Several inventors have recognized the importance of elevating a bone to make it more accessible to the animal. Several solutions rely on an external apparatus which holds a dog bone in an elevated or upright position. For example, U.S. Pat. Nos. 6,076,486 to Ollano and 6,311,639 to Stickney describe an external “base” apparatus which secures the bone in an elevated or upright position.

Another solution, sold by the Hartz Mountain Corporation, relies on injection molding the dog bone in a functional shape. The shape employs an asymmetric cantilever design, such that a dog can push down with its paw on the shorter end and elevate the longer end to chew on it.

While both this functional shape, and the solutions employing a base, serve to elevate the bone, there are a number of disadvantages to both approaches:

Disadvantages of the “Base” solution to elevating a bone:

(a) Most dogs enjoy carrying their bones around and chewing on them in different locations. Utilizing a base to elevate the bone introduces a disadvantage in immobilizing the bone. In order to serve as a base, such apparatus must either be large, heavy, or anchor itself with a tether or suction cups

(b) There is a disadvantage of required compatibility between the base and the bone that it holds. While the base can employ different means to “hold” a wider range of commercially-available bones, they are unlikely to be universally compatible. Many embodiments incorporate a coupling device into both the bone and the base, so that they fit and lock together. This can be disadvantageous to the consumer, in that they must either continually buy “refills” specifically designed for that base, or find other bones that are compatible with the base.

(c) Another disadvantage is that it requires the pet owner to perform a certain amount of maintenance in order to keep the toy functional. If the base accepts bones with “knots” at both ends, the owner must remove the bone, turn it over, and lock it back into the base after the animal consumes one end of it. If the bones are one-sided, the owner must frequently remove the leftover “stump” of the old bone, and lock a new one into the base.

(d) If an unanchored base becomes overturned during use, the animal cannot easily manipulate it back into the upright position. It will likely either lose interest in the bone, or require the help of the pet owner to return the toy to a usable, upright position.

Disadvantages of the “Asymmetrical Cantilever” solution to elevating a bone:

(a) The primary disadvantage of this solution is that it is not intuitive for a dog. The dog must figure out via trial-and-error, or be taught by the pet owner, how to push down on the proper end of the bone and hold it down while it chews the other end.

(b) The bone is asymmetrical, and if the animal starts out chewing on the wrong end of the bone, the functionality of the shape will quickly be lost.

(c) This functional shape requires that the dog has a great deal of manual dexterity. It also requires that the animal be both sufficiently intelligent and motivated, so that it can manipulate the bone in a very specific manner in order to benefit from its functionality. This is likely more difficult for a dog to perform than for the animal to simply grasp and elevate the bone between its forepaws.

### OBJECTS AND ADVANTAGES OF THE INVENTION

Accordingly, several objects and advantages of my invention are:

(a) To provide a means of elevating a bone that does not immobilize the bone or confine it to one location.

(b) To provide an “all-in-one” solution to elevating a bone that does not require a consumer to purchase refill bones that are compatible with a particular base.

(c) To provide an elevated bone that requires no maintenance from the pet owner in order to fulfill its function.

(d) To provide an elevated bone that cannot be overturned and rendered unusable.

(e) To provide a functional shape that does not need to be understood by the animal in order to be used by it.

(f) To provide a symmetrical shape that performs its elevating function regardless of which end faces up, or which end the animal starts chewing on.

(g) To provide a functional shape that elevates the bone, making it easier for the animal to access, without requiring any manual dexterity or physical manipulation by the animal.

Further objects and advantages are to provide a functional shape that has a stable standing position regardless of its orientation, which provides an animal with several bones to choose from, which can be rolled and played with and carried by the animal. Still further objects and advantages will become apparent from a consideration of the ensuing description and drawings.

### SUMMARY

The invention provides a symmetrical shape to be applied to dog bones, consisting of a core and multiple extensions from the core which serve to elevate the bone, making it easier for the animal to chew. Additionally, this shape is in the preferred embodiment completely freestanding and symmetrical, so that it will always remain “upright” and perform its function.

### BRIEF DESCRIPTION OF THE DRAWING

In the Drawing:

FIG. 1 is a perspective view of the animal toy of the preferred embodiment of the invention.

FIG. 2 is a top view of the animal toy of FIG. 1.

FIG. 3 is a side view of the animal toy of FIG. 1.

FIG. 4 is a front view of the animal toy of FIG. 1.

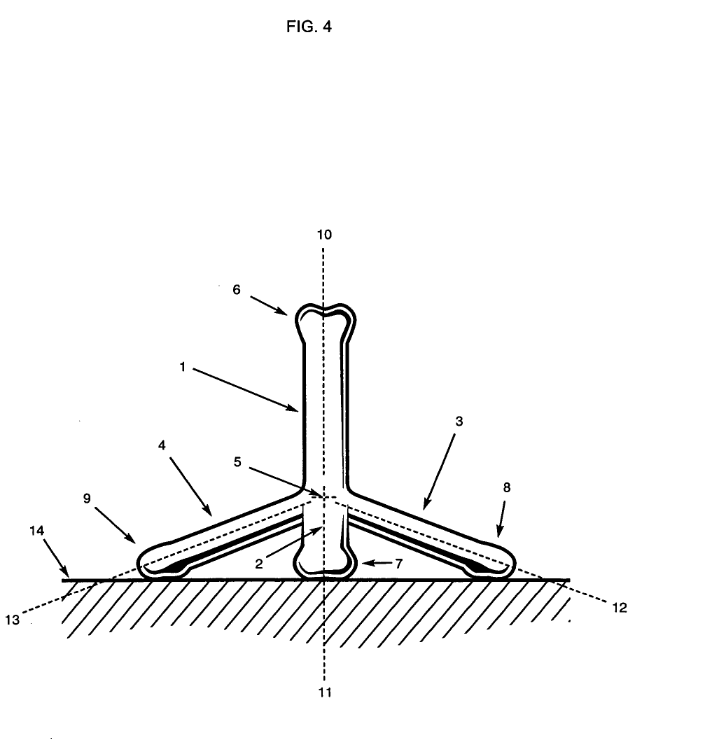

FIG. 5 is a perspective view of a dog chewing the animal toy of FIG. 1.

FIG. 6 is a perspective view of a dog “rolling” the animal toy of FIG. 1.

FIG. 7 is a perspective view of a “tied rawhide” embodiment of the animal toy FIG. 1

FIG. 8 is a perspective view of an alternate embodiment which optimizes the essential shape for production.

FIG. 9 is a view of alternate designs for “knobs” at the end of tie “legs”

FIG. 10 is a perspective view of alternate embodiment with “single-ball” “knobs” at the end of the “legs”

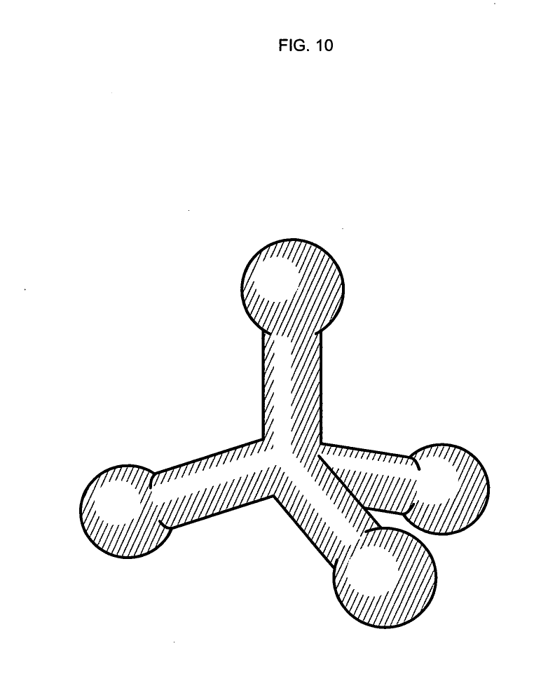

FIG. 11 is a perspective view of alternate of an alternate embodiment using springs and bells for pet cats.

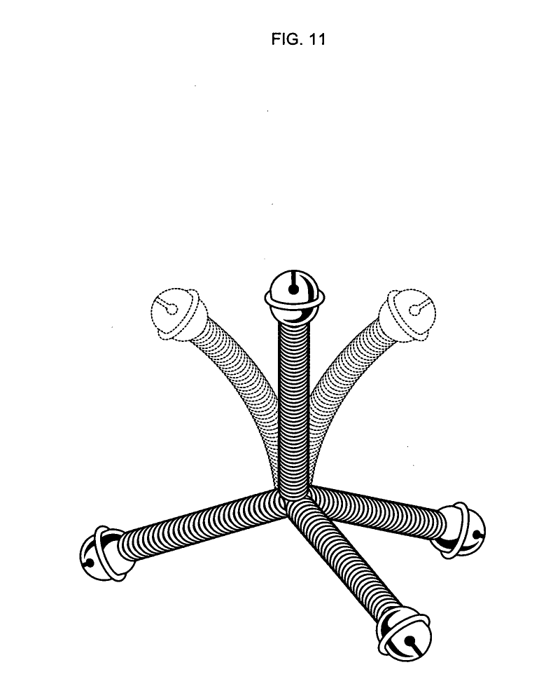

### DRAWINGS—Reference Numerals

1 leg (first)
2 leg (second)
3 leg (third)
4 leg (fourth)
5 origin point
6 knob (first leg)
7 knob (second leg)
8 knob (third leg)
9 knob (fourth leg)
10 axis (first leg)
11 axis (second leg)
12 axis (third leg)
13 axis (fourth leg)
14 floor surface
15 dog
16 dog's forepaws
17 pivot axis

### DETAILED DESCRIPTION OF THE INVENTION

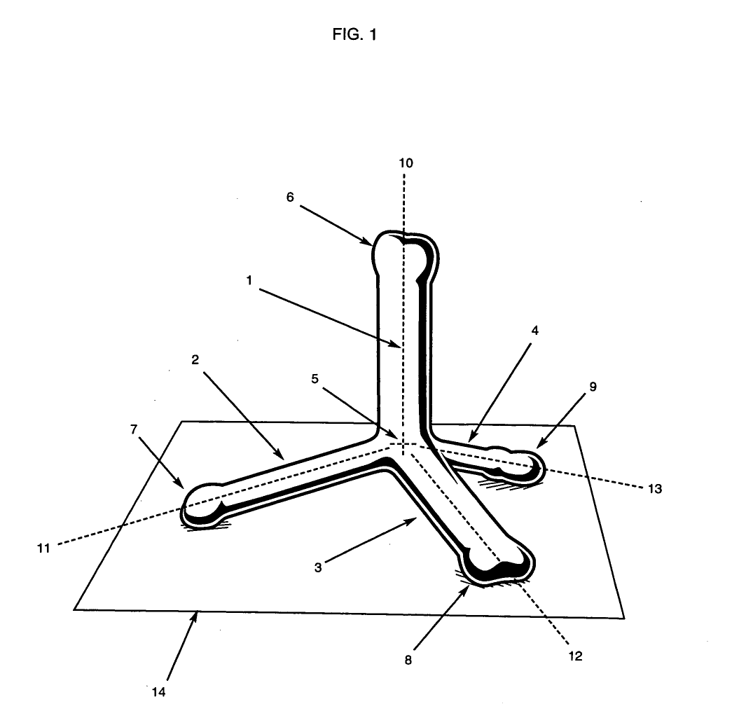

In the preferred embodiment as shown in FIG. 1, the animal toy is preferably injection molded using an edible/digestible polymer. FIG. 1 shows the animal toy from a perspective view, resting on a floor surface 14. In the following text, the animal toy is subdivided for explanation. The essential shape of the animal toy is best described in terms of the angles between four axes (an axis 10, an axis 11, an axis 12, and an axis 13), that converge at an origin point 5, also referred to as the core means.

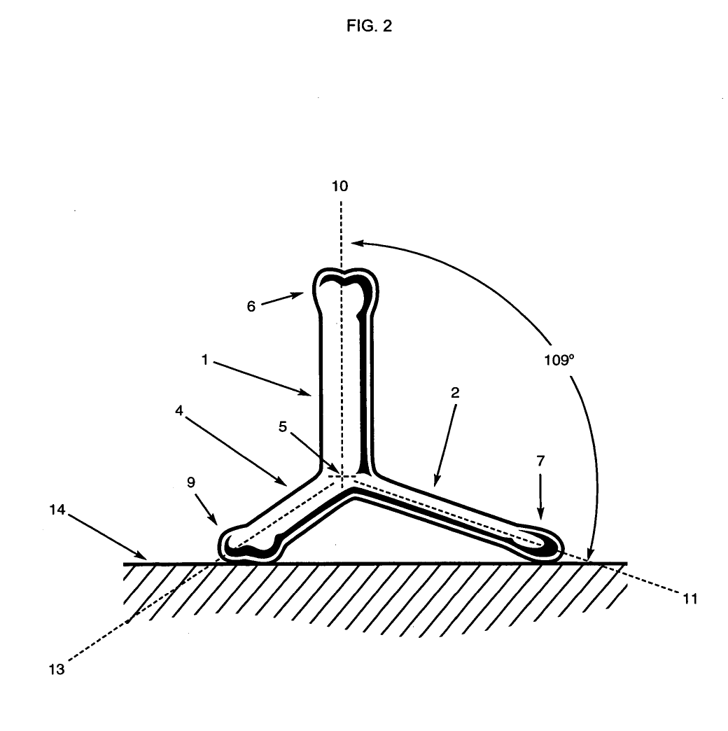

In the preferred embodiment as shown in FIG. 1, the animal toy consists of four equally sized bone-shaped legs, also referred to as multiple leg means. These four legs radiate from origin point 5 along their respective axes. Shown in FIG. 2, a leg 1 projects vertically from origin point 5 along axis 10, and terminates with a knob 6. A leg 2 projects from origin point 5 along axis 11 and terminates with a knob 7. The angle separating leg 1 and axis 10 from leg 2 and axis 11 is 109°, relative to origin point 5. Shown in FIG. 1, a leg 3 projects from origin point 5 along axis 12 and terminates with a knob 8. The angle separating leg 1 and axis 10 from leg 3 and axis 12 is 109°, relative to origin point 5. A leg 4 projects from origin point 5 along axis 13 and terminates with a knob 9. The angle separating leg 1 and axis 10 from leg 4 and axis 13 is 109°, relative to origin point 5.

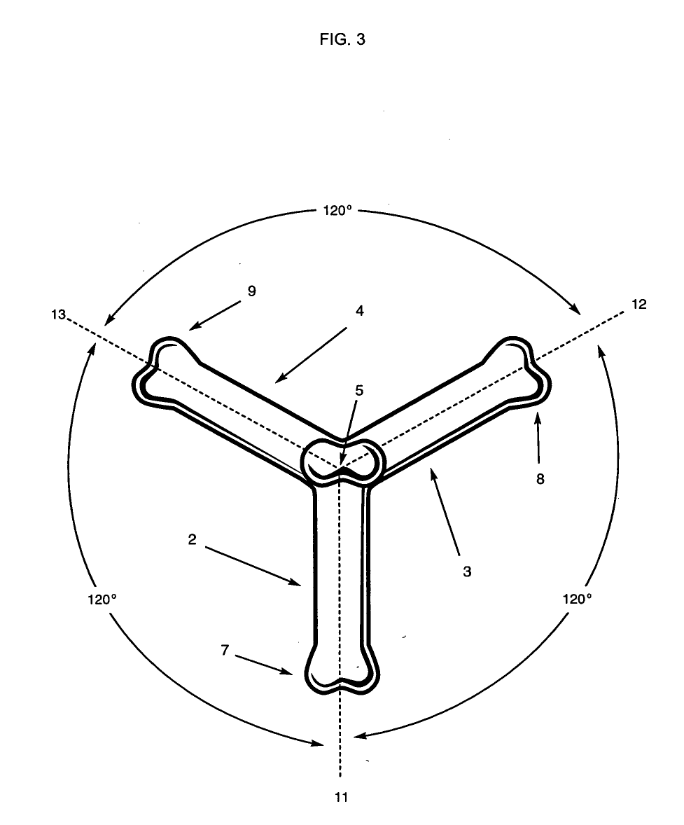

As shown in FIG. 3, leg 2 and axis 11 are separated from leg 3 and axis 12 by an angle of 120°, relative to origin point 5. Leg 3 and axis 12 are separated from leg 4 and axis 13 by an angle of 120°, relative to origin point 5. Leg 4 and axis 13 are separated from leg 2 and axis 11 by an angle of 120°, relative to origin point 5.

The animal toy performs its primary function by using any three legs for support, while elevating the fourth to give an animal easy access to it. The knobs at the ends of the legs provide a surface that can be chewed on from a variety of angles.

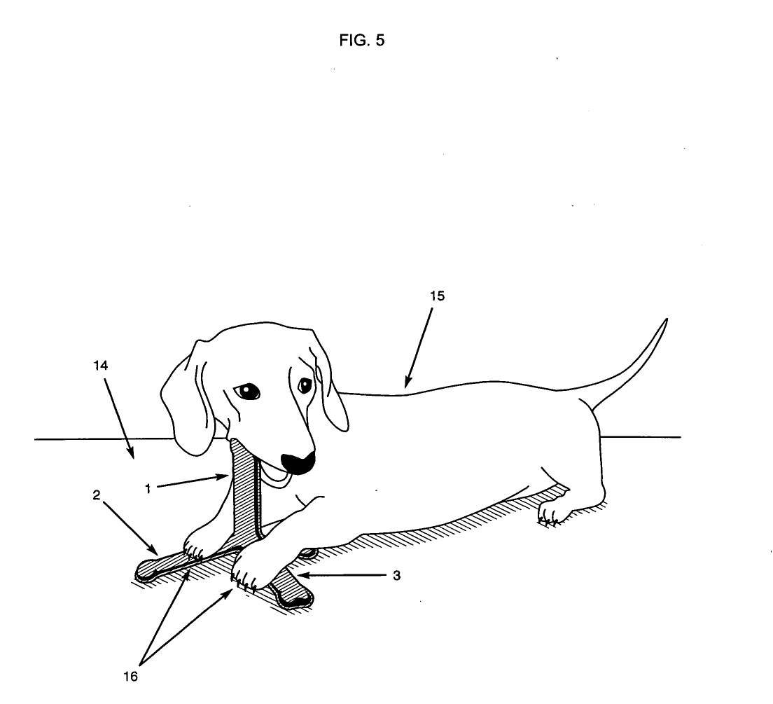

The animal toy is shaped such that regardless of how the toy is oriented, it will fall into one of four possible standing positions. Consider FIG. 1 to be the first such position. Legs 2, 3, and 4 are serving as supports to elevate leg 1 for the animal to access. Knobs 7, 8, and 9 at the end of legs 2,3, and 4 rest on the floor surface 14, supporting the animal toy so that leg 1 is raised vertically from the floor. In the second standing position, legs 1, 3, and 4 serve as supports to elevate leg 2. In the third standing position, legs 1, 2, and 4 serve as supports to elevate leg 3. In the fourth standing position, legs 1, 2, and 3 serve as supports to elevate leg 4. Thus, no matter what orientation the animal toy may stand, that is, no matter which three of the four legs 1, 2, 3 or 4 stands on the floor or other horizontal surface, the fourth leg will always be upright. As shown in FIG. 5, the dog 15 can use its forepaws 16 to apply downward pressure on two of the supporting legs (2 and 3) to further stabilize the animal toy.

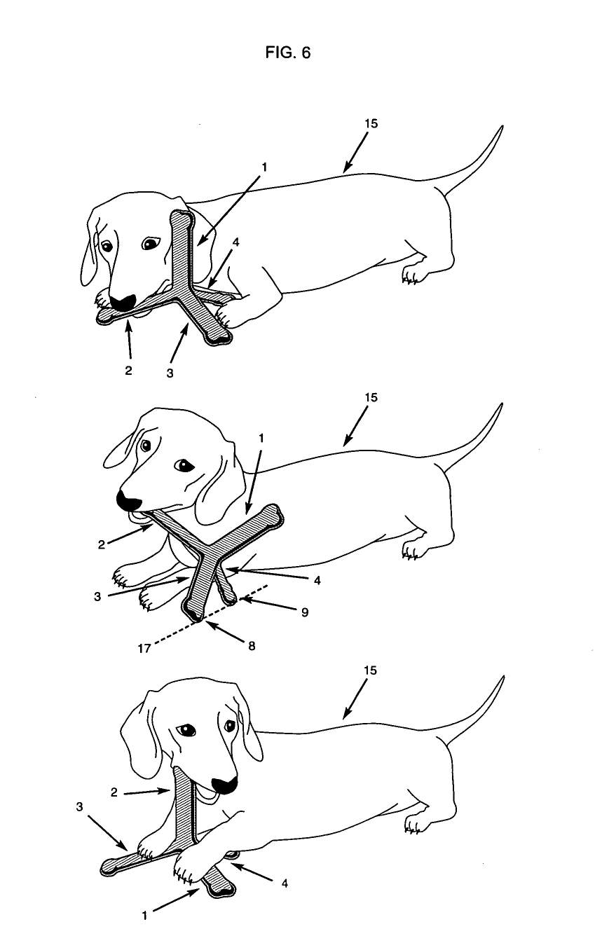

The animal toy's secondary function is that it provides four individual chew toys for an animal to select from while using the animal toy, which car prolong the animal's interest in the toy. The animal can also derive additional entertainment from “rolling” the toy. The toy's shape allows an animal to roll it into another standing position with minimal effort. For example, as shown in FIG. 6, the dog 15 can take hold of supporting leg 2 and elevate it towards the upright position. The animal toy will pivot along an axis 17, which connects the points where knobs 8 and 9 touch the floor surface 14. The dog 15 needs only to lift leg 2 a bit more than half way towards the vertical position, and the weight of leg 1 will cause the animal toy to fall into a standing position with leg 2 elevated.

### ADDITIONAL EMBODIMENTS

There are several additional embodiments of the essential shape and function of the dog bone of the invention:

(a) Size: The shape can be implemented in a variety of sizes, both proportionally, and through variation in the length, shape, cross-sectional shape and thickness of the legs, and the size and shape of the knobs at the end of the legs.

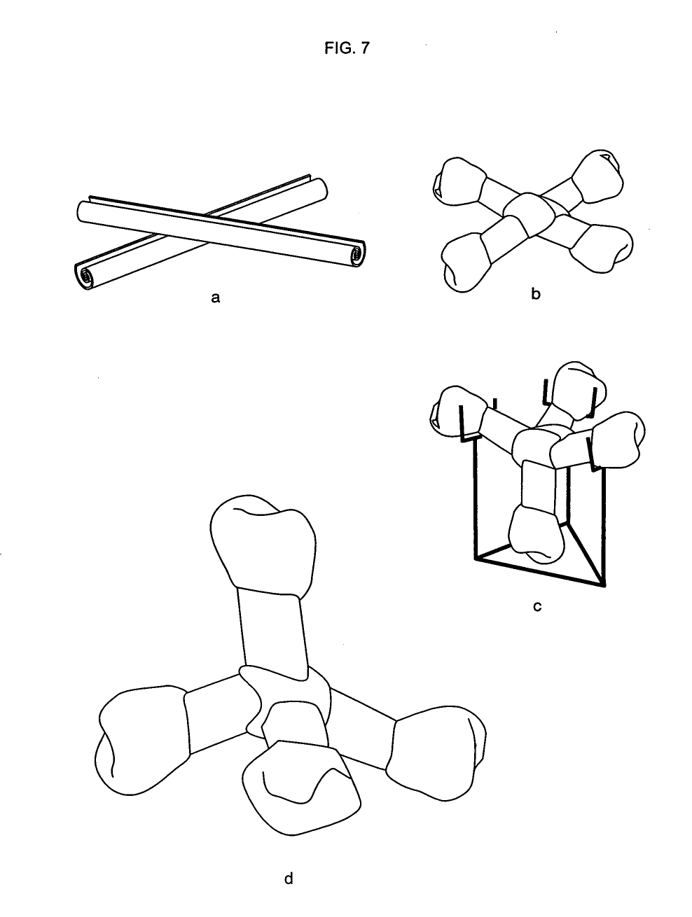

(b) Material: The shape can be implemented using a variety of natural and synthetic substrates, including but not limited to: non-digestible polymers (plastic, polyurethane, nylon, rubber, thermopolymer, vinyl), digestible polymers (corn-based, wheat-based, rice-based, potato-based, gleutin-based, casein/caseinate-based, and milk protein-based polymer formulations), rawhide (granulated rawhide, pressed rawhide, and tied rawhide). The shape can be created from tied rawhide by tying two pieces of rawhide together, and letting it dry on a properly shaped “form” as shown in FIG. 7.

(c) Functional Additives: A functional medical/medicinal substance can be added to any acceptable substrate material during the manufacturing process. Some examples of such substances are: clorophyl/parsley/mint for teeth-cleaning and breath-freshening, or glucosamine for arthritic or troubled joints.

(d) Scent/Flavoring Agents: A variety of scent and/or flavoring agents can be added to the material during or after manufacturing. These include, but are not limited to, natural and synthetic agents that simulate or are derived from: chicken, beef, pork, fish, bacon, mint, dog-safe chocolate (synthetic or carob-based), and peanut or peanut butter.

(e) Secondary Texture: The essential, freestanding shape of the dog bone can augmented with a secondary texture, such as a profusion of small bumps covering its surface, in order to lend secondary functionality to the shape, such as to better clean an animal's teeth.

The angles previously described as 109 degrees can be increased or decreased in order to alter the angle of the upright bone with respect to the plane that it stands on. A similar, symmetrical, freestanding shape can also be accomplished using more than four legs, such as six legs.

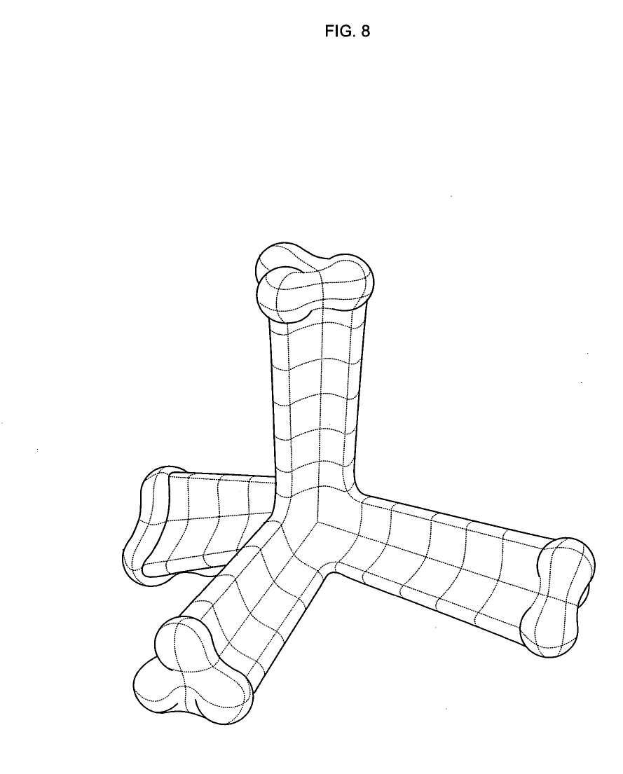

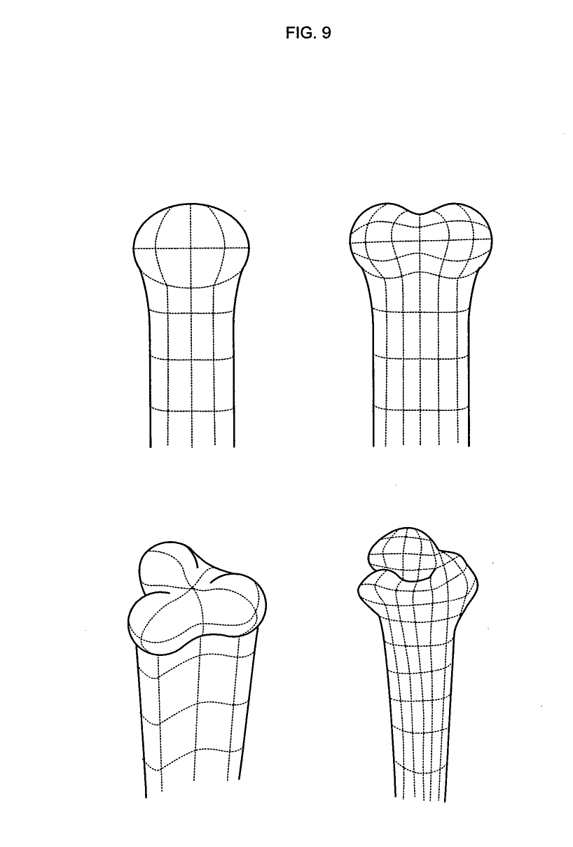

Alternate designs for the specific shapes of four the bones that comprise the freestanding shape include: alterations to the “knobs” at the ends of the bones (ranging from a simple ball, to a 2 or 3 ball “bone knot,” or even a realistic bone shape, all shown in FIG. 9). The shape of the “bone stems,” as well as the shape of the bone's cross section can also be varied in order to present a different visual appeal, or to simplify the injection-molding process. FIG. 8 shows an alternative design that optimizes two aspects of production. Firstly, the Y-shaped cross section of the legs greatly reduces the amount of material needed to mold the overall shape. Secondly, the combination of “3-ball” designs for the knob shape, and the Y-shaped leg cross section, present an absolutely symmetrical shape. This allows the injection mold itself to consist of 4 identical pieces, and for the molded shape to cleanly eject from such a mold, without having to flex or be forced.

Another alternate embodiment of the freestanding shape is one that is “multi-flavored.” This involves creating each of the bone's four legs out of differently flavored, or differently formulated, materials. This could be accomplished using an injection-molding setup with four separate entry points for material injection, located at the end of each leg. The mold could then be filled using a different material or flavor at each entry point, creating a shape with each leg having a different flavor.

Coloring agents can also be added to molding formulations in order to present a more alluring color to either animals, or the humans who will buy the bone for the animals. The previously described method for making a multi-flavored bone can be used to add a different color to each of the four legs.

### CONCLUSION, RAMIFICATIONS AND SCOPE

It will thus be seen that the invention of a symmetrical, freestanding functional shape for dog bones will provide many benefits including:
Easier for the animal to gain benefits of the material
Reduces neck strain
Increases interest in productive chewing.

While the foregoing is illustrative of preferred and alternate embodiments of the invention, other embodiments may be had within the scope of the invention.

1. A toy for pet animals, comprising:
a. Core means,
b. Multiple leg means, said multiple leg means comprising multiple legs at least in part being connected to and at least in part radially extending from said core means,
c. Toy support means, said toy support means comprising at least two of said legs adapted to support said toy on a planar surface and
d. Upwardly extending means, said upwardly extending means comprising at least one upwardly extending leg of said multiple leg means adapted to extend above said planar surface and to be accessible for chewing by the pet.

2. A toy for pet animals in accordance with claim 1, wherein at least part of said toy comprises pet-chewable material.

3. A toy for pet animals in accordance with claim 1, wherein at least part of said toy comprises pet-chewable edible material.

4. A toy for pet animals in accordance with claim 1, wherein said multiple leg means comprises at least four leg means, said toy support means comprises at least three of said leg means and said upwardly extending means comprises at least a fourth of said leg means.

5. A toy for pet animals in accordance with claim 1, wherein said multiple leg means comprises at least four legs of which at least three legs ire of substantially equal size, said toy support means comprises at least three of said legs of substantially equal size and said upwardly extending means comprises at least a fourth of said legs.

6. A toy for pet animals in accordance with claim 1, wherein said multiple leg means comprises at least four legs each of which at least three legs are of substantially equal size, said toy support means comprises at least three of said legs of substantially equal size which extend radially from said core means at substantially equal angles to each other and said upwardly extending means comprises at least a fourth of said legs.

7. A toy for pet animals in accordance with claim 1, said toy being composed at least in part of digestible polymers.

8. A toy for pet animals in accordance with claim 1, said toy being composed at least in part of non-digestible polymers.

9. A toy for pet animals in accordance with claim 1, said toy being composed at least in part of rawhide.

10. A toy for pet animals in accordance with claim 1, said toy being composed at least in part of functional additives.
